(19) United States
(12) Patent Application Publication
(10) Pub. No.: US 2023/0421205 A1
(43) Pub. Date: Dec. 28, 2023

(54) DIGITAL DONOR CARD FOR A DISTRIBUTED ANTENNA UNIT SUPPORTING MULTIPLE VIRTUAL RADIO POINTS

(71) Applicant: CommScope Technologies LLC, Hickory, NC (US)

(72) Inventors: Luigi Tarlazzi, Boxborough, MA (US); Arthur J. Barabell, Sudbury, MA (US)

(73) Assignee: CommScope Technologies LLC, Hickory, NC (US)

(21) Appl. No.: 18/339,826

(22) Filed: Jun. 22, 2023

Related U.S. Application Data
(60) Provisional application No. 63/354,584, filed on Jun. 22, 2022.

(51) Int. Cl. H04B 7/022; H04W 56/00

(52) U.S. Cl. CPC H04B 7/022; H04W 88/085; H04W 56/001

(57) ABSTRACT

One embodiment is directed to a converged system comprising at least one donor base station entity configured to support natively working with multiple radio points and a distributed antenna system communicatively coupled to the donor base station entity. The distributed antenna system is configured to instantiate multiple virtual radio points for the donor base station entity. The distributed antenna system is configured to serve the donor base station entity using the multiple virtual radio points instantiated by the distributed antenna system for the donor base station entity. Other embodiments are disclosed.

### CROSS-REFERENCE TO RELATED APPLICATIONS

This application claims the benefit of U.S. Provisional Patent Application Ser. No. 63/354,584, filed on Jun. 22, 2022, which is hereby incorporated herein by reference in its entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote units” or “remote antenna units”), where each access point can be coupled directly to one or more of the central access nodes or indirectly via one or more other access points and/or via one or more intermediary or expansion units or nodes (also referred to here as “transport expansion nodes (TENs)”). A DAS is typically used to improve the coverage provided by one or more base stations that are coupled to the central access nodes. These base stations can be coupled to the one or more central access nodes via one or more cables or via a wireless connection, for example, using one or more donor antennas. The wireless service provided by the base stations can include commercial cellular service and/or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals that are radiated from one or more coverage antennas associated with that access point. The downlink radio frequency signals are radiated for reception by user equipment. Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits them to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, this involves, among other things, combining or summing uplink signals received from multiple access points in order to produce the base station signal provided to each base station. In this way, the DAS increases the coverage area for the uplink capacity provided by the base stations.

A DAS can use either digital transport, analog transport, or combinations of digital and analog transport for generating and communicating the transport signals between the central access nodes, the access points, and any transport expansion nodes.

Traditionally, each base station is coupled to a DAS using the analog RF interface that would otherwise be used to directly connect the base station to a set of antennas.

Another way to couple a base station to a DAS is to connect a baseband unit (BBU) of the base station directly to the DAS using a digital fronthaul interface that the BBU would otherwise use to communicate with a remote radio head (RRH). One example of a digital fronthaul interface is the Common Public Radio Interface (CPRI). A digital donor card can be deployed in a central access node of a DAS. The digital donor card is used to couple a BBU of the base station directly to the DAS without using an analog radio frequency (RF) interface. Although each digital donor card is typically configured to implement one or more physical digital donor interfaces, each such physical digital donor interface has traditionally been configured to be coupled to a single BBU and to appear, from the perspective of that BBU, to be a single RRH. That is, even if a BBU has features that can use multiple RRHs, traditionally these features were not able to be exploited when the BBU is coupled to a DAS. This is because the DAS, in such deployments, appears, from the perspective of the BBU, to be a single RRH.

### SUMMARY

One embodiment is directed to a converged system comprising at least one donor base station entity configured to support natively working with multiple radio points and a distributed antenna system communicatively coupled to the donor base station entity. The distributed antenna system is configured to instantiate multiple virtual radio points for the donor base station entity. The distributed antenna system is configured to serve the donor base station entity using the multiple virtual radio points instantiated by the distributed antenna system for the donor base station entity.

Another embodiment is directed to a method performed using a converged system comprising at least one donor base station entity configured to support natively work with multiple radio points. The converged system further comprises a distributed antenna system communicatively coupled to the donor base station entity. The distributed antenna system is configured to instantiate multiple virtual radio points for the donor base station entity. The distributed antenna system comprises a virtual radio point donor interface and a plurality of access points. Each virtual radio point is implemented using the virtual radio point donor interface and a respective one or more of the access points. The respective one or more of the access points used to implement each virtual radio point comprises a respective simulcast zone for that virtual radio point. The method comprises: receiving, from the donor base station entity, downlink control-plane messages and downlink user-plane messages for each of the multiple virtual radio points; communicating the downlink control-plane messages and the downlink user-plane messages for each of the multiple virtual radio points to the one or more access points in the respective simulcast zone for the respective virtual radio point; receiving, at each of the one or more access points in the respective simulcast zone for each virtual radio point, the downlink control-plane messages and the downlink user-plane messages for the respective virtual radio point; generating, at each of the one or more access points in the respective simulcast zone for each virtual radio point, downlink analog radio frequency signals for the respective virtual radio point using the downlink control-plane messages and the downlink user-plane messages for the respective virtual radio point; and wirelessly transmitting, from each of the one or more access points in the respective simulcast zone for each virtual radio point, the respective downlink analog radio frequency signals generated for the respective virtual radio point.

Other embodiments are disclosed.

The details of various embodiments are set forth in the accompanying drawings and the description below. Other features and advantages will become apparent from the description, the drawings, and the claims.

### BRIEF DESCRIPTION OF DRAWINGS

FIG. 1 is a block diagram of one exemplary embodiment of a converged system in which virtual radio points implemented using the resources of a distributed antenna system can be used to serve a multi-radio-point donor base station entity.

FIG. 2 comprises a high-level flowchart illustrating one exemplary embodiment of a method of providing wireless communication in a downlink direction using a multi-RP donor base station entity and a set of virtual radio points implemented using the resources of a distributed antenna system.

FIG. 3 comprises a high-level flowchart illustrating one exemplary embodiment of a method of providing wireless communication in an uplink direction using a multi-RP donor base station entity and a set of virtual radio points implemented using the resources of a distributed antenna system.

FIGS. 4-11 illustrate various use cases for the embodiment of the converged system shown in FIG. 1.

Like reference numbers and designations in the various drawings indicate like elements.

### DETAILED DESCRIPTION

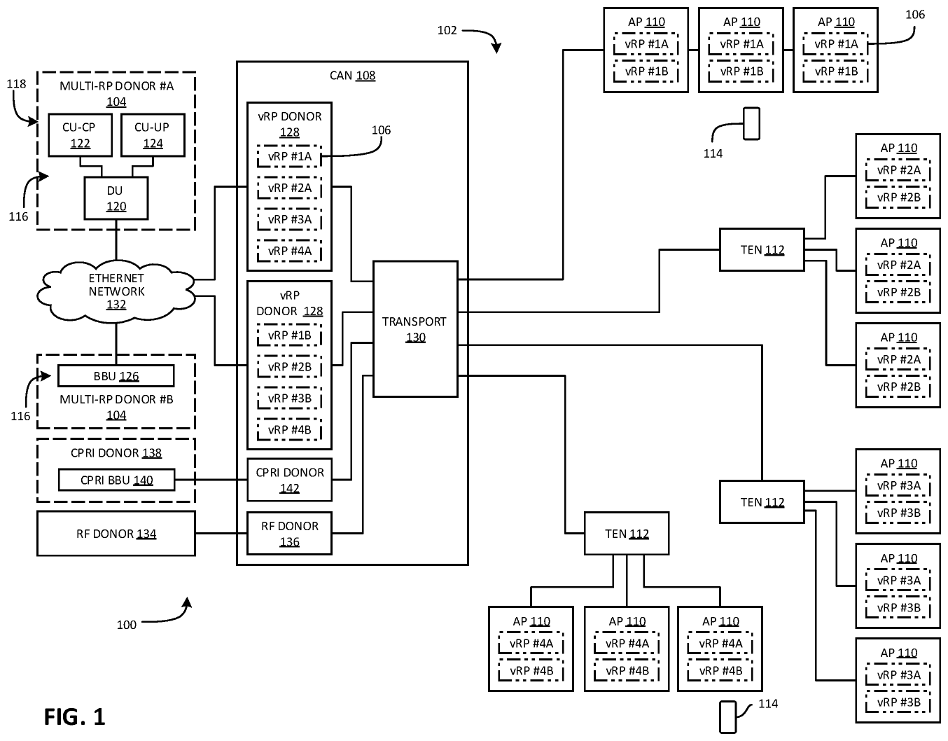

FIG. 1 is a block diagram of one exemplary embodiment of a converged system 100 in which the virtual radio point features described below can be used. The converged system 100 shown in FIG. 1 implements at least one base station to provide wireless service for a cell using a distributed antenna system (DAS) 102.

The converged system 100 is “converged” in the sense that at least some of the donor base station entities used with the DAS 102 are configured to natively support (and include features that take advantage of) wirelessly transmitting and receiving radio frequency (RF) signals using multiple remote radio heads (RRH), radio point (RP), or radio unit (RU) entities and that the DAS 102 is configured to natively support implementing multiple “virtual” RRH, RP, or RU entities in way that enables each such donor base station entities to individually communicate and interact with each of the virtual multiple RRH, RP, or RU entities implemented for that donor base station entity. In the following description, the donor base station entities used with the DAS 102 that are configured to natively support (and include features that take advantage of) wirelessly transmitting and receiving RF signals using multiple RRH, RP, or RU entities are also referred to here as “multi-RP donor base station entities” 104 or simply “multi-RP donors” 104. Also, the virtual RRH, RP, or RU entities implemented by the DAS 102 for use with such multi-RP donors 104 are also referred to here as “virtual RPs” 106 or simply “vRPs” 106.

In the exemplary embodiment shown in FIG. 1, the DAS 102 includes one or more central access nodes (CANs) 108 (also referred to as “master units,” “host units,” or “hub units”) that are communicatively coupled to a plurality of remotely located access points 110 (also referred to as “antenna units,” “radio units,” “remote units,” or “remote antenna units”), where each access point 110 can be coupled directly to one or more of the central access nodes 108 or indirectly via one or more other access points 110 and/or via one or more transport expansion nodes (TENs) 112 (also referred to as “intermediary” or “expansion” units or nodes). Each access point 110 includes, or is otherwise associated with, a respective set of coverage antennas (not shown) via which downlink analog RF signals can be radiated to user equipment (UEs) 114 and via which uplink analog RF signals transmitted by UEs 114 can be received. However, it is to be understood that the DAS 102 can be implemented in other ways. The DAS 102 can be implemented in a virtualized manner or a non-virtualized manner. In this example, the DAS 102 uses digital transport; however, analog transport or a combination of digital and analog transport could be used. Also, in the exemplary embodiment shown in FIG. 1, each access point 110 is configured so that it can serve (that is, transmit and receive RF signals for) multiple donor base station entities simultaneously.

For each multi-RP donor 104, each vRP 106 instantiated for it is associated with and implemented using a respective set of access points 110 of the DAS 102. This set of access points 110 is also referred to here as the “simulcast zone” for that vRP 106. In one implementation of this embodiment, the respective simulcast zones associated with the various vRPs 106 instantiated for a given multi-RP donor 104 all differ from each other. A simulcast zone differs from another simulcast zone when the respective sets of access points 110 are not the same (that is, when the respective sets of access points 110 include different access points 110, which can also be referred to as the respective sets of access points 110 being “disjoint” as that term is used in set theory).

In general, one or more vRPs 106 are implemented using the resources of the DAS 102 in order to serve each multi-RP donor 104 used with the system 100. Each multi-RP donor 104 comprises a set of one or more baseband entities 116 that, together with the one or more vRPs 106 implemented for the donor 104, are used to implement a logical base station to provide wireless service for a cell.

In the example shown in FIG. 1, a first multi-RP donor 104 (multi-RP donor #A) and the set of vRPs 106 (vRPs #1A, #2A, #3A, and #4A) implemented for it are used to implement a 5G NR base station, for which the set of one or more baseband entities 116 comprises one or more central unit entities (CUs) 118 and one or more distributed unit entities (DUs) 120. In this example, each CU 118 can implement Layer 3 and non-time critical Layer 2 functions for the base station. Each CU 118 can be further partitioned into one or more control-plane entities (referred to as “CU-CPs”) 122 and one or more user-plane entities (referred to as “CU-UPs”) 124 that handle the control-plane and user-plane processing of the CU 118, respectively. Also, for this first multi-RP donor 104, each DU 120 can implement the time critical Layer 2 functions and at least some of the Layer 1 functions for the base station.

Other base stations can be implemented in other ways. In the example shown in FIG. 1, a second multi-RP donor 104 (multi-RP donor #B) and the set of vRPs 106 (vRPs #1B, #2B, #3B, and #4B) implemented for it are used to implement a 4G LTE base station, for which the set of one or more baseband entities 116 comprises a single baseband unit (BBU) or controller 126 that is configured to implement the Layer-3, Layer-2, and at least some of the Layer-1 functions for the second base station. It is to be understood, however, that other base stations can be implemented in other ways.

Each vRP 106 is configured to implement any physical layer functions for the corresponding base station that are not implemented by the one or more baseband entities 116 for the corresponding multi-RP donor 104 as well as the RF interface for the base station.

As noted above, traditionally, when a BBU of a base station is coupled directly to a DAS using a digital donor card, the physical interface implemented by the digital donor card is typically configured to be coupled to a single BBU and to appear, from the perspective of that BBU, to be a single RP, even if that BBU has features that can use multiple RPs. In contrast to a traditional DAS, the DAS 102 of the converged system 100 is configured to instantiate one or more vRPs 106 for any multi-RP donor 104 (and the corresponding set of baseband entities 116) coupled to the DAS 102. In the exemplary embodiment shown in FIG. 1, each CAN 108 comprises one or more virtual radio point (vRP) donor interfaces 128. Also, in the exemplary embodiment shown in FIG. 1, each CAN 108 comprises one or more transport interfaces 130, each of which is configured to couple one or more access points 110 and/or TENs 112 to the CAN 108. In this exemplary embodiment, each vRP 106 is instantiated and implemented by the DAS 102 in a distributed manner in which at least a part of each vRP 106 is implemented in a vRP donor interface 128 included in the CAN 108 and at least a part of each vRP 106 is implemented in the access points 110 in the simulcast zone for that vRP 106. Each vRP 106 can be implemented using other entities of the DAS 102 (for example, a timing or synchronization entity and/or a management entity).

Each vRP donor interface 128 and transport interface 130 can be implemented, for example, as a dedicated vRP donor card and transport card, can be implemented at least in part using one or more virtualized network functions (VNF), or can be implemented in other ways.

In this embodiment, each multi-RP donor 104 (and the associated set of one or more baseband entities 116 for it) can be coupled to a respective vRP donor interface 128 using a switched Ethernet network 132 and the CAN 108 includes one or more Ethernet network interfaces (not shown) to couple the CAN 108 (and the vRP donor interfaces 128 included therein) to the Ethernet network 132. It is to be understood that each multi-RP donor 104 (and the associated set of one or more baseband entities 116 for it) can be coupled to the vRP donor interface 128 in other ways (for example, using one or more Ethernet point-to-point links).

For each multi-RP donor 104 (and the associated set of one or more baseband entities 116 for it), each vRP 106 instantiated for that multi-RP donor 104 is configured to appear to the baseband entities 116 as a separate radio unit (RU), radio point (RP), or remote radio head (RRH) of the type that the multi-RP donor 104 and associated set of one or more baseband entities 116 are configured to work with natively. As a part of doing this for each vRP 106, resources of the DAS 102 (including, for example, the vRP donor interface 128 and the access points 110 included in the simulcast zone for that vRP 106) are configured to implement the control-plane, user-plane, synchronization-plane, and management-plane functions that such a RU, RP, or RRU would implement in order to be used with the corresponding set of baseband entities 116. Each vRP 106 appears to the associated set of one or more baseband entities 116 to be a separate, single RU, RP, or RRH even though one or more access points 110 are actually being used to wirelessly transmit and receive RF signals for that vRP 106.

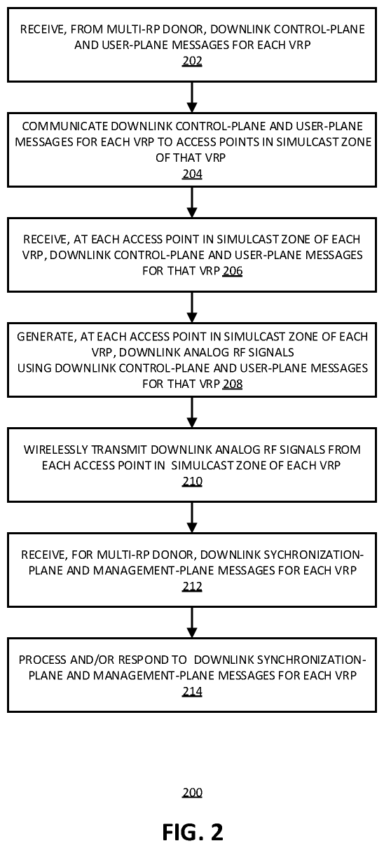

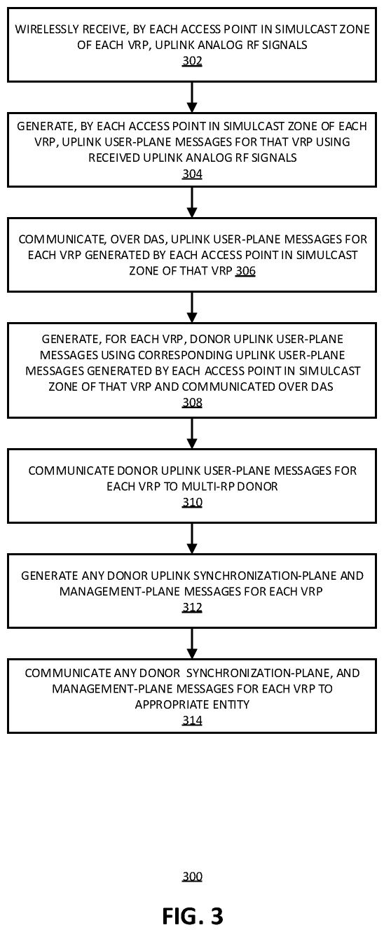

One example of how this can be done is described below in connection with FIGS. 2 and 3.

The O-RAN Alliance publishes various specifications for implementing radio access networks (RANs) in an open manner. “O-RAN” is an acronym that also stands for “Open RAN,” but in this description references to “O-RAN” should be understood to be referring to the O-RAN Alliance, one or more specifications published by the O-RAN Alliance, and/or entities or interfaces implemented in accordance with one or more specifications published by the O-RAN Alliance.

As noted above, the first multi-RP donor 104 and the set of vRPs 106 implemented for it are used to implement a 5G NR base station and the set of vRPs 106 are configured to implement a set of RUs of the type that the corresponding CU-CP 122, CU-UP 124, and DU 120 are configured to work with natively. If the first multi-RP donor 104 is configured to implement a 5G NR base station in accordance with O-RAN where the corresponding CU-CP 122, CU-UP 124, and DU 120 are implemented as an O-RAN CU-CP 122, O-RAN CU-UP 124, and O-RAN DU 120, respectively, each vRP 106 instantiated for that set of baseband entities 116 is configured to appear, to the O-RAN CU-CP 122, O-RAN CU-UP 124, and O-RAN DU 120, to be an O-RAN RU and each vRP 106 would be configured to implement the various features that O-RAN requires an O-RAN RU to implement. Alternatively, if the first multi-RP donor 104 is configured to implement a 5G NR base station in a different way (for example, is implemented in accordance with a combination of public and proprietary standards or specifications), each vRP 106 instantiated for the corresponding set of baseband entities 116 would be configured to appear, to the set of baseband entities 116, to be an RU implemented in accordance with those public and proprietary standards or specifications and each vRP 106 would be configured to implement the various features that those public and proprietary standards or specifications require that type of RU to implement.

For example, if the second multi-RP donor 104 is configured to implement a 4G LTE base station in accordance with a combination of public standards (for example, the 3GPP 4G LTE standards) and proprietary vendor-specific specifications, each vRP 106 used with the second multi-RP donor 104 would be configured to appear, to the set of baseband entities 116, to be a RRH, RP, or RU implemented in accordance with those standards and specifications and each vRP 106 would be configured to implement the various features that those standards and specifications require that type of RRH, RP, or RU to implement.

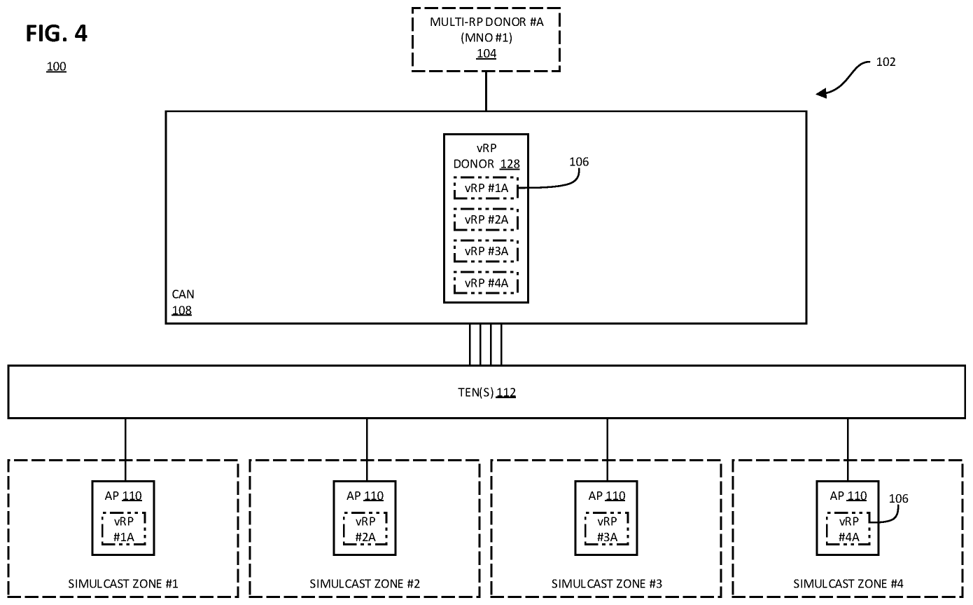

In general, the wireless coverage of each vRP 106 instantiated by the DAS 102 can be improved by radiating a set of downlink RF signals for that vRP 106 from the coverage antennas associated with multiple access points 110 in the simulcast zone of that vRP 106 and by producing a single set of uplink user-plane data for that vRP 106 by a combining or summing process that uses inputs derived from the uplink RF signals received via the coverage antennas associated with the multiple access points 110 in the simulcast zone of that vRP 106, where the resulting final single set of uplink user-plane data for that vRP 106 is provided to the multi-RP donor 104. However, in some embodiments and use cases (for example as shown in FIGS. 4, 6, 7, 8, 9, and 11), the simulcast zone for each vRP 106 implemented for a given multi-RP donor 106 includes only a single access point 110 and, as a result, the combining or summing process need not be formed for those vRPs 106.

The combining or summing process used for a vRP 106 that includes multiple access points 110 in its respective simulcast zone can be performed in a centralized manner in which the combining or summing process for each vRP 106 is performed by a single unit of the DAS 102 (for example, by the associated CAN 108). This combining or summing process can also be performed for each vRP 106 that includes multiple access points 110 in its respective simulcast zone in a distributed or hierarchical manner in which the combining or summing process is performed by multiple units of the DAS 102 (for example, the associated CAN 108 and one or more TENs 112 and/or access points 110). Each unit of the DAS 102 that performs the combining or summing process for a given vRP 106 receives uplink data for that vRP 106 from one or more “southbound” entities associated with that unit, combines or sums corresponding user-plane data contained in the received uplink data for that vRP 106 as well as any corresponding user-plane data generated at that unit from uplink RF signals received via coverage antennas associated with that unit (which would be the case if the unit is a “daisy-chained” access point 110), generates uplink data containing the combined user-plane data for that vRP 106, and communicates the resulting uplink data for that vRP 106 to the appropriate “northbound” entities coupled to that unit. As used here, “southbound” refers to traveling in a direction “away,” or being relatively “farther,” from the CAN 108 and donor base stations, and “northbound” refers to traveling in a direction “towards”, or being relatively “closer” to, the CAN 108 and donor base stations. As used here, the southbound entities of a given unit are those entities that are subtended from that unit in the southbound direction, and the northbound entities of a given unit are those entities from which the given unit is itself subtended from in the southbound direction.

As noted above, the DAS 102 can also include one or more TENs 112. For each vRP 106 served using a TEN 112, the TEN 112 is configured to receive a set of uplink data containing user-plane data for that vRP 106 from a group of southbound entities (that is, from access points 110 and/or other TENs 112) and perform the uplink combining or summing process described above in order to generate uplink data containing combined user-plane data for that vRP 106 if necessary, which the TEN 112 transmits northbound towards the CAN 108 serving that vRP 106. Each TEN 112 also forwards northbound all other uplink data (for example, uplink management-plane and synchronization-plane data and any other user-plane data) received from its southbound entities.

Each TEN 112 can be implemented as a physical network function using dedicated, special-purpose hardware. Alternatively, each TEN 112 can be implemented as a virtual network function running on a server.

Also, one or more access points 110 can be configured in a “daisy-chain” or “ring” configuration in which transport data for at least some of those access points 110 is communicated via at least one other access point 110. If a vRP 106 served by such a daisy-chained access point 110 is one for which the user-plane combining or summing process described above is performed (that is, because vRP 106 has multiple access points 110 in its simulcast zone), that access point 110 would also perform the user-plane combining or summing process described above for that vRP 106 in order to combine or sum uplink user-plane data generated at that access point 110 with corresponding uplink user-plane data for that vRP 106 received from any southbound entity subtended from that access point 110. Such an access point 110 also forwards northbound all other uplink transport data received from any southbound entity subtended from it and forwards to any southbound entity subtended from it all downlink transport data received from its northbound entities.

In this exemplary embodiment, the multi-RP donors 104 are configured to use an Option 7-2 functional split and communicate user-plane data to and from the multiple RRHs, RPs, or RUs they are configured to work with in a frequency-domain format. Because the multi-RP donors 104 are configured to use an Option 7-2 functional split, the associated vRPs 106 are configured to perform the Layer-1 processing not performed by the corresponding baseband entities 116. Also, in this exemplary embodiment, the multi-RP donors 104 are configured to use a digital fronthaul interface that natively supports being communicated over a switched Ethernet network. Examples of such a fronthaul interface include the O-RAN fronthaul interface, an evolved CPRI (eCPRI) interface, an IEEE 1914.3 Radio-over-Ethernet (RoE) interface, and proprietary versions thereof.

In this exemplary embodiment, the digital fronthaul interface format natively used for communicating over the DAS 102 comprises a digital synchronous or streaming interface. Examples of such a fronthaul interface include the Common Public Radio Interface (CPRI) interface and proprietary versions thereof. Other types of fronthaul splits and/or fronthaul interfaces can be used by the multi-RP donor units 104 and/or for communicating over the DAS 102.

Also, the DAS 102 is configured so that the vRPs 106 instantiated for each multi-RP donor 104 also implement any special functions or features used by the multi-RP donor 104 in order to leverage the multi-RP nature of the multi-RP donor 104 and associated set of baseband entities 116. By implementing such special multi-RP features and by being able to instantiate multiple virtual radio points 106 for any multi-RP donor 104, those multi-RP features implemented by the multi-RP donor 104 that use multiple RUs, RPs, or RRHs can still be used when the multi-RP donor 104 is used with the DAS 102. Examples of such multi-RP features include uplink interference rejection combining (IRC) receivers, noise muting receivers, or selection combining receivers, downlink frequency reuse, and uplink frequency reuse. Uplink IRC receivers, noise muting receivers, or selection combining receivers implemented by a multi-RP donor 104 use user-plane data received via multiple RPs in performing the uplink receiver processing for each UE. Also, in this context, “downlink frequency reuse” refers to situations where separate downlink user data intended for different UEs is simultaneously wirelessly transmitted to the UEs using the same physical resource blocks (PRBs) for the same cell. Likewise, “uplink frequency reuse” refers to situations where separate uplink user data is simultaneously wirelessly transmitted from different UEs using the same PRBs for the same cell. Typically, frequency reuse can be used when the UEs “in reuse together” are sufficiently physically separated from each other so that the co-channel interference resulting from the different simultaneous wireless transmissions is sufficiently low (that is, where there is sufficient RF isolation). Generally, for those PRBs where downlink or uplink frequency reuse is used, the associated base station needs to be able to use different RPs to communicate with different UEs that are in reuse together. The RPs used to implement this type of frequency reuse may need to implement special features that support transmitting different sets of control-plane and user-plane messages for each of the UEs in reuse and that support determining which subset of RPs should be used for wirelessly communicating with each UE. Combining receiver and frequency reuse functions supported by the multi-RP donors 104 can still be used when used with the system 100 even though the DAS 102 is used because the DAS 102 is able to instantiate multiple, separate virtual radio points 106 for any multi-RP donor 104 coupled to the DAS 102 and implements any needed special multi-RP features or functions.

The DAS 102 can be used with donor base station entities that are not natively configured to work with multiple-RPs and for which the DAS 102 is configured to appear as a single RP of the type that the donor base station entity is configured to natively work with. The DAS 102 is configured to serve (and transmit and receive RF signals for) each of these non-multi-RP donor base station entities using a respective set of access points 110 of the DAS 102, where the respective set of access points 110 used to serve each such donor base station entity is also referred to here as the “simulcast zone” for that entity.

One example of such a donor base station entity that can be used with the DAS 102 include a donor base station 134 that is coupled to the DAS 102 using the external analog radio frequency (RF) interface of the base station 134 that would otherwise be used to couple the base station 134 to one or more antennas (if the DAS 102 were not being used). This type of donor base station 134 is also referred to here as an “RF donor base station” 134 or “RF donor” 134. Each RF donor 134 can be coupled to the DAS 102 using an RF donor interface 136 deployed in the CAN 108.

Each RF donor interface 136 can be implemented, for example, as a dedicated RF donor card, can be implemented at least in part using one or more virtualized network functions (VNF), or can be implemented in other ways.

Each RF donor interface 136 is configured to receive analog downlink RF signals from each such RF donor base station 134, convert the received analog downlink RF signals to the digital fronthaul interface format natively used in the DAS 102 (for example, by digitizing, digitally down-converting, and filtering the received analog downlink RF signals), and communicate the resulting downlink transport data to the various access points 110 included in a simulcast zone for that base station 134. The access points 110 in the simulcast zone for that RF donor base station 134 receive the downlink transport data and use it to generate and wirelessly transmit downlink RF signals from the set coverage antennas associated with the access points 110 for reception by the UEs 114 served by that RF donor base station 134. Likewise, the access points 110 in the simulcast zone for that RF donor base station 134 receive uplink RF signals transmitted by UEs 114 being served by that RF donor base station 134 and use them to generate uplink transport data that is communicated northbound over the DAS 102 towards the appropriate CAN 108.

Ultimately, a single set of uplink transport data is produced for each RF donor base station 134 served by the DAS 102 by performing a combining or summing process (that combines or sums corresponding user-plane data) using inputs derived from the uplink RF signals received via the access points 110 in the simulcast zone of that RF donor 134. This can be done in a centralized or distributed manner and can be done in a way that is similar to the way the combining or summing process is performed for each vRP 106. The resulting set of uplink transport data (which includes combined or summed user-plane data) for each RF donor 134 is used by the corresponding RF donor interface 136 to produce a set of analog uplink RF signals (for example, by digitally up-converting and performing a digital-to-analog conversion process), and to communicate the analog uplink RF signals to the RF donor base station 134.

Another example of a non-multi-RP donor base station entity 138 that can be used with the DAS 102 is a BBU 140 that is configured to use an Option 8 functional split to communicate with a remote radio head (RRH) (if the DAS 102 were not being used) using an appropriate digital fronthaul interface. In the example shown in FIG. 1, the digital fronthaul interface comprises a time-domain baseband IQ fronthaul interface implemented in accordance with the Common Public Radio Interface (“CPRI”) specification. This type of donor base station 138 is also referred to here as a “CPRI donor base station” 138 or “CPRI donor” 138, and this type of BBU 140 is also referred to here as a “CPRI BBU” 140.

Each CPRI donor 138 and associated CPRI BBU 140 can be coupled to the DAS 102 using a CPRI donor interface 142 deployed in the CAN 108.

Other donor base stations can be coupled to the DAS 102 using other digital donor interfaces and other digital fronthaul interfaces.

Each digital donor interface is configured to receive downlink data from each digital donor coupled to that digital donor interface in the digital baseband fronthaul interface format used by the associated BBU, convert the received downlink data to the digital fronthaul interface format natively used in the DAS 102 (for example, by re-sampling, synchronizing, combining, separating, gain adjusting, etc.), and communicate the resulting downlink transport data to the various access points 110 included in a simulcast zone for that digital donor. The access points 110 in the simulcast zone for that digital donor receive the downlink transport data and use it to generate and wirelessly transmit downlink RF signals from the set coverage antennas associated with the access points 110 for reception by the UEs 114 served by that digital donor. Likewise, the access points 110 in the simulcast zone for that digital donor receive uplink RF signals transmitted by UEs 114 being served by that digital donor and use them to generate uplink transport data that is communicated northbound over the DAS 102 towards the appropriate CAN 108.

Ultimately, a single set of uplink transport data is produced for each digital donor served by the DAS 102 by performing a combining or summing process (that combines or sums corresponding user-plane data) using inputs derived from the uplink RF signals received via the access points 110 in the simulcast zone of that digital donor. This can be done in a centralized or distributed manner and can be done in a way that is similar to the way the combining or summing process is performed for each vRP 106. The resulting set of uplink transport data (which includes combined or summed user-plane data) for each digital donor is used by the corresponding donor interface to produce or format uplink data in accordance with the digital baseband fronthaul interface format used by that digital donor (for example, by re-sampling, synchronizing, combining, separating, gain adjusting, etc.), and communicate the resulting uplink data to the BBU associated with that digital donor.

In general, the various donor base station entities are configured to communicate with a core network (not shown) of the associated wireless operator using an appropriate backhaul network (typically, a public wide area network such as the Internet).

Each of the donor base station entities 104, 134, and 138, CANs 108, access points 110, TENs 112, and any of the specific features implemented thereby and components thereof (including, for example, the vRP donor interfaces 128), can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.). Such entities can be implemented in other ways.

FIG. 2 comprises a high-level flowchart illustrating one exemplary embodiment of a method 200 of providing wireless communication in a downlink direction using a multi-RP donor base station entity 104 and a set of virtual radio points 106 implemented using the resources of a DAS 102. The embodiment of method 200 shown in FIG. 2 is described here as being implemented using the system 100 described above in connection with FIG. 1. However, it is to be understood that other embodiments can be implemented in other ways.

The blocks of the flow diagram shown in FIG. 2 have been arranged in a generally sequential manner for ease of explanation; however, it is to be understood that this arrangement is merely exemplary, and it should be recognized that the processing associated with method 200 (and the blocks shown in FIG. 2) can occur in a different order (for example, where at least some of the processing associated with the blocks is performed in parallel and/or in an event-driven manner). Also, most standard exception handling is not described for ease of explanation; however, it is to be understood that method 200 can and typically would include such exception handling. Moreover, one or more aspects of method 200 can be configurable or adaptive (either manually or in an automated manner).

Method 200 shown in FIG. 2 is performed for each multi-RP donor 104 that is coupled to the DAS 102, where the DAS 102 instantiates a respective set of vRPs 106 to serve each multi-RP donor 104 and where each such vRP 106 is implemented using a respective set of access points 110. As noted above, the set of access points 110 used for each vRP 106 is also referred to here as the “simulcast zone” for that vRP 106.

Method 200 comprises receiving, from each multi-RP donor 104, downlink control-plane and user-plane messages for each vRP 106 instantiated for that multi-RP donor 104 (block 202) and communicating the received downlink control-plane and user-plane messages for each vRP 106 to the access points 110 included in the respective simulcast zone associated with that vRP 106 (block 204).

In the example described here in connection with the system 100 shown in FIG. 1, the multi-RP donor 104 generates downlink control-plane and user-plane messages for each vRP 106 that are formatted in accordance with the digital fronthaul interface natively supported by the multi-RP donor 104 and communicates the messages over the Ethernet network 132 to the vRP donor interface 128 for that vRP 106. For each vRP 106 implemented by a vRP donor interface 128, the vRP donor interface 128 receives the downlink control-plane and user-plane messages for each vRP 106 and communicates them to the access points 110 included in the simulcast zone for that vRP 106. The vRP donor interfaces 128 communicates each such message to each access point 110 included in the simulcast zone of the associated vRP 106 by forwarding the message to the transport interface 130 used to communicatively couple that access point 110 to the CAN 108, which encapsulates or otherwise formats the message in accordance with the digital fronthaul interface used by the DAS 102 and communicates the resulting transport data southbound over the DAS 102 towards that access point 110. As noted above, downlink transport data communicated over the DAS 102 from the CAN 108 may be communicated directly to an access point 110 or may be communicated via one or more intermediary nodes (for example, one or more TENs 112 or other access points 110).

Method 200 further comprises receiving, at each access point 110 in the simulcast zone of each vRP 106, the downlink control-plane and user-plane messages for that vRP 106 (block 206), generating, by each access point 110 in the simulcast zone of each vRP 106, a respective set of downlink analog RF signals using the downlink control-plane and user-plane messages for that vRP 106 (block 208), and wirelessly transmitting, by each access point 110 in the simulcast zone of each vRP 106, the respective set of downlink analog RF signals generated for that vRP 106 (block 210).

The downlink RF analog signals wirelessly transmitted from each access point 110 can be wirelessly transmitted using the set of coverage antennas associated with that access point 110.

The downlink control-plane and user-plane messages can be received at each access point 110 in the simulcast zone of each vRP 106 by receiving the downlink transport data transmitted southbound from the corresponding transport interface 130 and extracting the downlink control-plane and user-plane messages for the vRP 106. As noted above, the downlink transport data communicated over the DAS 102 from the CAN 108 may be communicated directly to each access point 110 or may be communicated via one or more intermediary nodes (for example, one or more TENs 112 or other access points 110).

How each access point 110 generates the set of downlink analog RF signals using downlink control-plane and user-plane messages depends on the functional split used by the associated multi-RP donor 104. In the example described here in connection with the system 100 shown in FIG. 1 where each multi-RP donor 104 is configured to use an Option 7-2 functional split and communicate user-plane data in a frequency-domain form for each antenna port of the vRP 106, each access point 110 in the simulcast zone of the vRP 106 is configured to perform the low physical layer baseband processing and RF functions for each antenna port of the vRP 106 using the respective downlink control-plane and user-plane messages for that vRP 106 received by that access point 110. This is done in order to generate a corresponding downlink RF signal for wireless transmission from a respective coverage antenna associated with that access point 110. Other functional splits can be used. For example, where each multi-RP donor 104 is configured to use an Option 8 functional split and communicate user-plane data in a time-domain form for each antenna port of the vRP 106, each access point 110 in the simulcast zone of the vRP 106 is configured to perform the RF functions for each antenna port of the vRP 106 using the respective downlink control-plane and user-plane messages for that vRP 106 received by that access point 110. This is done in order to generate a corresponding downlink RF signal for wireless transmission from a respective coverage antenna associated with that access point 110.

As noted above, the DAS 102 is configured so that the vRPs 106 instantiated for each multi-RP donor 104 also implement any special functions or features necessary for the multi-RP donor 104 to leverage the multi-RP nature of the multi-RP donor 104. In connection with doing this, each such vRP 106 implements any processing of the downlink control-plane and user-plane messages needed to implement such features. For example, where a multi-RP donor 104 supports downlink frequency reuse and in connection therewith communicates different sets of downlink control-plane and user-plane messages to different sets of RPs when a group of UEs 114 are in reuse together or otherwise communicates a downlink control-plane or user-plane message to some but not all of the RPs so that the associated transmissions can be selectively transmitted from only those RPs (for example, in order to reduce downlink interference or to determine which subset of RPs should serve each UE 114), the DAS 102 is configured to communicate each downlink control-plane and user-plane message to the appropriate vRPs 106 (and as a result, the appropriate access points 110) as intended by the multi-RU donor 104.

As noted above, each access point 110 can be used to serve multiple donors (which may include different types of donors and/or donors serving different wireless operators) and is configured to generate a respective set of downlink analog RF signals for each served donor. The corresponding downlink analog RF signals generated for the various donors can be combined and the resulting combined downlink analog RF signals can be wirelessly transmitted using a common set of coverage antennas associated with the access point 110.

Method 200 comprises receiving, for each multi-RP donor 104, downlink synchronization-plane and management-plane messages for each vRP 106 instantiated for that multi-RP donor 104 (block 212) and processes and/or responds to the received downlink synchronization-plane and management-plane messages for each vRP 106 (block 214).

In the example described here in connection with the system 100 shown in FIG. 1, the multi-RP donor 104 or one or more other entities associated with the multi-RP donor 104 (such as a timing master or management entity) generates downlink synchronization-plane and management-plane messages for each vRP 106 that are formatted in accordance with the digital fronthaul interface natively supported by the multi-RP donor 104 (or the other entities associated with the multi-RP donor 104) and communicates the messages over the Ethernet network 132 to the vRP donor interface 128 for that vRP 106.

For each vRP 106 implemented by a vRP donor interface 128, the vRP donor interface 128 receives the downlink synchronization-plane and management-plane messages for each vRP 106 and processes them accordingly. For example, the vRP donor interface 128 is configured to receive synchronization-plane messages for each vRP 106 and process them by using the message to synchronize the vRP 106 to the timing master associated with the messages. As a part of doing this, one or more units of the DAS 102 are configured accordingly (for example, the vRP donor interface 128 and access points 110 used to implement each vRP 106 are synchronized to the timing master associated with the synchronization-plane messages) and any responsive uplink synchronization-plane messages are generated and communicated to an appropriate entity (such as the multi-RP donor 104 or one or more other entities associated with the multi-RP donor 104) as described below in connection with blocks 312-314 of FIG. 3.

Also, the vRP donor interface 128 is configured to receive management-plane messages for each vRP 106 and process them by using the management-plane messages to configure the vRP 106 accordingly (for example, the vRP donor interface 128 and access points 110 used to implement each vRP 106 can be configured in accordance with the management-plane messages received for each vRP 106) and any responsive uplink management-plane messages are generated and communicated to the appropriate entity (such as the multi-RP donor 104 or one or more other entities associated with the multi-RP donor 104) as described below in connection with blocks 312-314 of FIG. 3.

FIG. 3 comprises a high-level flowchart illustrating one exemplary embodiment of a method 300 of providing wireless communication in an uplink direction using a multi-RP donor base station entity 104 and a set of virtual radio points 106 implemented using the resources of a DAS 102. The embodiment of method 300 shown in FIG. 3 is described here as being implemented using the system 100 described above in connection with FIG. 1. However, it is to be understood that other embodiments can be implemented in other ways.

The blocks of the flow diagram shown in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel and/or in an event-driven manner). Also, most standard exception handling is not described for ease of explanation; however, it is to be understood that method 300 can and typically would include such exception handling. Moreover, one or more aspects of method 300 can be configurable or adaptive (either manually or in an automated manner).

Method 300 shown in FIG. 3 is performed for each multi-RP donor 104 that is coupled to the DAS 102, where the DAS 102 instantiates a respective set of vRPs 106 to serve each multi-RP donor 104 and where each such vRP 106 is implemented using a respective set of access points 110 (that is, the access points 110 in the respective simulcast zone of that vRP 106).

Method 300 comprises wirelessly receiving, by each access point 110 included in the simulcast zone of each vRP 106 instantiated for the multi-RP donor 104, a respective set of uplink RF analog signals (block 302), generating, by each access point 110 included in the simulcast zone of each vRP 106, uplink user-plane messages for that vRP 106 using the received uplink RF analog signals received for that vRP 106 (block 304), and communicating, over the DAS 102, the uplink user-plane messages generated by each access point 110 in the simulcast zone of each vRP 106 (block 306). The uplink user-plane messages are communicated over the DAS 102 towards the CAN 108 coupled to the associated multi-RP donor 104.

The uplink RF analog signals wirelessly received at each access point 110 can be wirelessly received using the set of coverage antennas associated with that access point 110.

How each access point 110 generates the uplink user-plane messages using the respective received uplink RF analog signals depends on the functional split used by the associated multi-RP donor 104. In the example described here in connection with the system 100 shown in FIG. 1 where each multi-RP donor 104 is configured to use an Option 7-2 functional split and communicate user-plane data in a frequency-domain form for each antenna port of the vRP 106, each access point 110 in the simulcast zone of the vRP 106 is configured to perform the RF functions and low physical layer baseband processing for each antenna port of the base station 124 using the respective uplink analog RF signal. This is done in order to generate the corresponding uplink user-plane messages for transmission over the DAS 103 to the serving CAN 108. As noted above, other functional splits can be used. For example, where each multi-RP donor 104 is configured to use an Option 8 functional split and communicate user-plane data in a time-domain form for each antenna port of the vRP 106, each access point 110 in the simulcast zone of the vRP 106 is configured to perform the RF functions for each antenna port of the base station 124 using the respective uplink analog RF signal. This is done in order to generate the corresponding uplink user-plane messages for transmission over the DAS 103 to the serving CAN 108.

The uplink user-plane data generated for each vRP 106 served by a given access point 104 is encapsulated or otherwise formatted in accordance with the digital fronthaul interface used by the DAS 102 and communicates the resulting uplink transport data northbound over the DAS 102 towards the associated CAN 108. As noted above, uplink transport data communicated over the DAS 102 towards the CAN 108 may be communicated directly from the access point 110 to that CAN 108 or may be communicated via one or more intermediary nodes (for example, one or more TENs 112 or other access points 110).

As noted above, each access point 110 can be used to serve multiple donors (which may include different types of donors and/or donors serving different wireless operators) and the same set of coverage antennas can be used to receive uplink analog RF signals for each donor served by the access point and to perform the RF functions and low physical layer baseband processing for each donor separately in order to generate separate uplink user-plane data, which is all formatted in accordance with the digital fronthaul interface used by the DAS 102 and communicated northbound over the DAS 102.

Method 300 further comprises generating donor uplink user-plane messages for each vRP 106 derived from the uplink user-plane messages generated for that vRP 106 by the one or more access points 110 in the simulcast zone of that vRP 106 and communicated over the DAS 102 (block 308) and communicating the donor uplink user-plane messages for each vRP 106 to the multi-RP donor 104 (block 310).

As described above, in the example described here in connection with the system 100 shown in FIG. 1, uplink user-plane messages can be communicated from the access points 110 in the simulcast zone of the multi-RP donor 104 to the CAN 108 coupled to the multi-RP donor 104 via one or more intermediary units of the DAS 102 (such as one or more TENs 112 or daisy-chained access points 110).

Also, as described above, a single set of uplink user-plane messages are produced for each vRP 106 instantiated by the DAS 102 for each multi-RP donor 104. If the simulcast zone for a given vRP 106 includes more than one access point 110, the single set of uplink user-plane messages for that vRP 106 is produced using a combining or summing process that uses inputs derived from the uplink RF signals received via the coverage antennas associated with the access points 110 in that vRP's simulcast zone, where the resulting final single set of donor uplink user-plane data is provided to the multi-RP donor 104 for that vRP 106. Also, when this combining or summing process is used, it can be performed in a centralized manner in which the combining or summing process for a given vRP 106 is performed by a single unit of the DAS 102 (for example, by the associated CAN 108). This combining or summing process, when used, can also be performed for a given vRP 106 in a distributed or hierarchical manner in which the combining or summing process is performed by multiple units of the DAS 102 (for example, the associated CAN 108 and one or more TENs 112 and/or access points 110).

How the corresponding user-plane data is combined or summed for a vRP 106 having multiple access points 110 in its simulcast zone depends on the functional split used by the associated multi-RP donor 104. In the example described here in connection with the system 100 shown in FIG. 1 where each multi-RP donor 104 is configured to use an Option 7-2 functional split and communicate user-plane data in a frequency-domain form for each antenna port of the vRP 106, each unit of the DAS 102 that performs the combining or summing process (including the CAN 108) for a given vRP 106 is configured to extract, from the uplink user-plane messages received from each of its southbound entities, the respective frequency-domain baseband IQ data for each uplink antenna port of the vRP 106 and digitally sum the baseband IQ data associated with each resource element received from each of its southbound entities as well any baseband IQ data associated with each resource element generated at that unit from uplink RF signals received via a coverage antenna associated with that unit (which would be the case if the unit performing the combining or summing process is a “daisy-chained” access point 110). That is, the digital summing is performed on a resource-element-by-resource-element basis in this example.

As noted above, other functional splits can be used. For example, where each multi-RP donor 104 is configured to use an Option 8 functional split and communicate user-plane data in a time-domain form for each antenna port of the vRP 106, each unit of the DAS 102 that performs the combining or summing process (including the CAN 108) for a given vRP 106 is configured to extract, from the uplink user-plane messages received from each of its southbound entities, the respective time-domain baseband IQ data for each uplink antenna port of the vRP 106 and digitally sum the baseband IQ data associated with each sample period received from each of its southbound entities as well any baseband IQ data associated with each sample period generated at that unit from uplink RF signals received via a coverage antenna associated with that unit (which would be the case if the unit performing the combining or summing process is a “daisy-chained” access point 110). That is, the digital summing is performed on a sample-period-by-sample-period basis in this example.

The summing or combining described here as being performed in the CAN 108 can be performed by the vRP donor interface 128 (for example, where the uplink user-plane messages received at the CAN 108 from each of its southbound entities using the various transport interfaces 130 are provided to the appropriate vRP donor interface 128 for summing or combining) and/or can be performed by another entity in or associated with the CAN 108 (for example, a backplane or FPGA used to couple the various transport interfaces 130 to the appropriate vRP donor interface 128).

Also, as noted above, the DAS 102 is configured so that the vRPs 106 instantiated for each multi-RP donor 104 also implement any special functions or features used by the multi-RP donor 104 in order to leverage the multi-RP nature of the multi-RP donor 104. In connection with doing this, each such vRP 106 implements any processing of the uplink RF signals and/or uplink user-plane messages needed to implement such features. For example, where a multi-RP donor 104 supports uplink frequency reuse and in connection therewith needs to receive different sets of uplink user-plane messages from different sets of RUs when a group of UEs 114 are in reuse together and/or to receive separate uplink user-plane messages from each of the RUs so that the multi-RP donor 104 has the ability to process those user-plane message separately (for example, in order to implement an uplink IRC, noise muting, or selection combining receiver or in order to determine which subset of RUs should be serve each UE 114), the DAS 102 is configured to perform the uplink summing or combining of uplink user-plane data described above separately for each vRP 106 and communicate the resulting uplink user-plane messages for each vRP 106 to the multi-RP donor 104.

The donor uplink control-plane and user-plane messages for each vRP 106 can be communicated to the multi-RP donor 104 via the switched Ethernet network 132 used to couple the corresponding multi-RP donor 104 to the DAS 102.

Method 300 further comprises generating any necessary donor uplink synchronization-plane and management-plane messages for each vRP 106 instantiated for that multi-RP donor 104 (block 314) and communicates them to the appropriate entity (block 316).

As noted above, the DAS 102 receives downlink synchronization-plane and management-plane messages for each of the vRPs 106 instantiated by the DAS 102 for each multiple-RP donor 104 and process the received downlink synchronization-plane and management-plane messages for each vRP 106. As a part of doing this, any necessary donor uplink synchronization-plane and management-plane messages are generated for each vRP 106 and communicated to the multi-RP donor 104 or one or more other entities associated with the multi-RP donor 104 (such as a timing master or management entity). Any necessary donor uplink synchronization-plane and management-plane messages for each vRP 106 can be communicated to the appropriate entity via the switched Ethernet network 132 used to couple the corresponding multi-RP donor 104 to the DAS 102.

By performing the processing described above in connection with FIGS. 2 and 3 for each of the vRPs 106 instantiated and implemented for each multi-RP donor 104, each such vRP 106 will appear to the multi-RP donor 104 (and the associated set of one or more baseband entities 116) to be a separate, single RU, RP, or RRH of the type that the multi-RP donor 104 is configured to work with. As a result, each vRP 106 is able to perform the processing necessary for it to appear to the associated multi-RP donor 104 (and the associated set of baseband entities 116) as a separate radio unit RU, RP, or RRH of the type that the multi-RP donor 104 is configured to work with, even though multiple access points 110 may actually being used to wirelessly transmit and receive RF signals for each vRP 106.

FIGS. 4-11 illustrate various use cases for the embodiment of the converged system 100 shown in FIG. 1.

FIG. 4 illustrates a use case in which a single multi-RP donor 104 is coupled to the DAS 102 (more specifically, to a single vRP donor interface 128 of the CAN 108). In this use case, the DAS 102 instantiates four vRPs 106 for the corresponding multi-RP donor 104 (the base station and cell implemented thereby). In this use case, the simulcast zone for each vRP106 includes only one access point 110. Also, in this example, only a single mobile network operator (MNO) is being served. In this use case, the resources of the DAS 102 are used to instantiate and implement multiple vRPs 106 for the single multi-RP donor 104 coupled to the DAS 102 (where those vRPs 106 implement any special functions or features used by the multi-RP donor 104 in order to leverage the multi-RP nature of the multi-RP donor 104), which enables the multi-RP donor 104 to use the multi-RP features it supports (such as uplink IRC, noise muting, or selection combining receivers, downlink frequency reuse, and uplink frequency reuse).

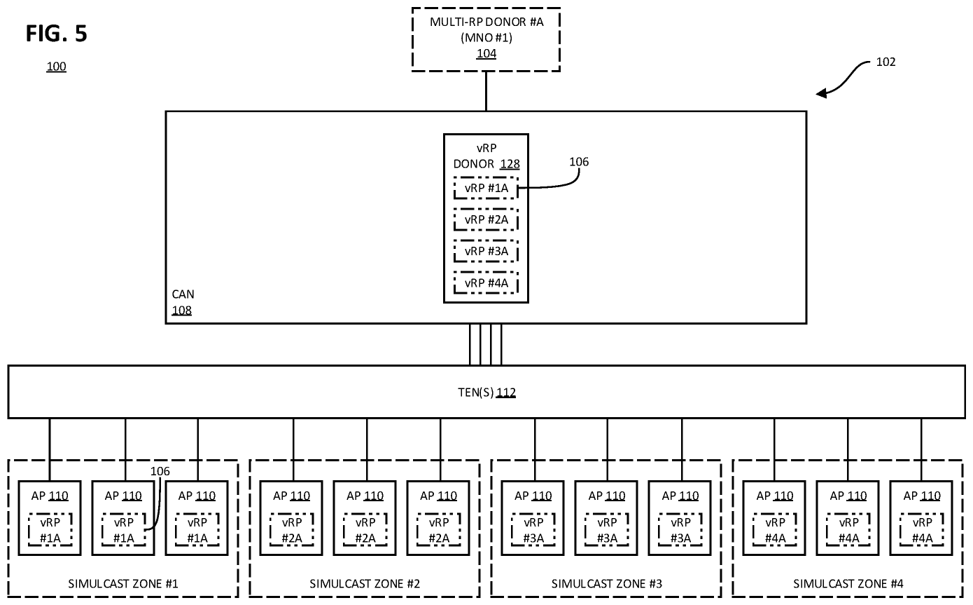

FIG. 5 illustrates a use case that is similar to the one shown in FIG. 4, except that the simulcast zone for each vRP 106 includes multiple access points 110. That is, in this use case, having multiple access points 110 in the simulcast zone for each vRP 106 instantiated and implemented by the DAS 102 for the multi-RP donor 104 enables the coverage enhancement features provided by the DAS 102 (that is, simulcasting the downlink signals for each vRP 106 from the multiple access points 110 in the vRP's simulcast zone and by combining or summing uplink signals for each vRP 106 received using the multiple access points 110 in the vRP's simulcast zone) to be provided for each vRP 106. This enables the multi-RP donor 104 to leverage both the coverage enhancement features of the DAS 102 and the multi-RP features it supports.

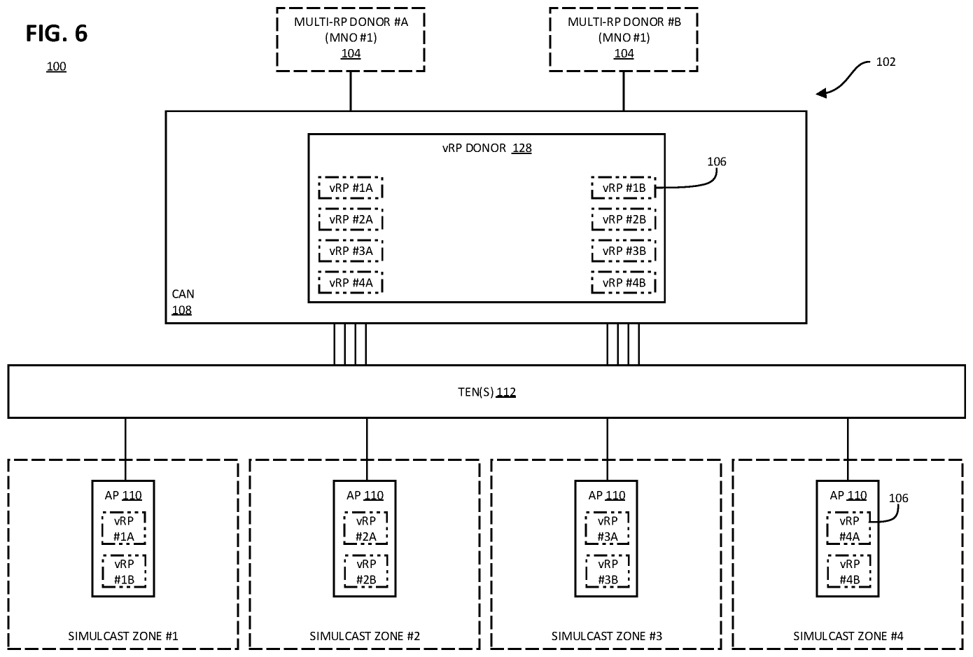

FIG. 6 illustrates a use case in which two multi-RP donors 104 are coupled to a single vRP donor interface 128 in a CAN 108 of the DAS 102. The DAS 102 instantiates a respective four vRPs 106 for each served multi-RP donor 104 (and the respective base station and cell implemented thereby). The simulcast zone for each vRP 106 includes only one access point 110 in this example. Also, in this example, only a single mobile network operator (MNO) is being served.

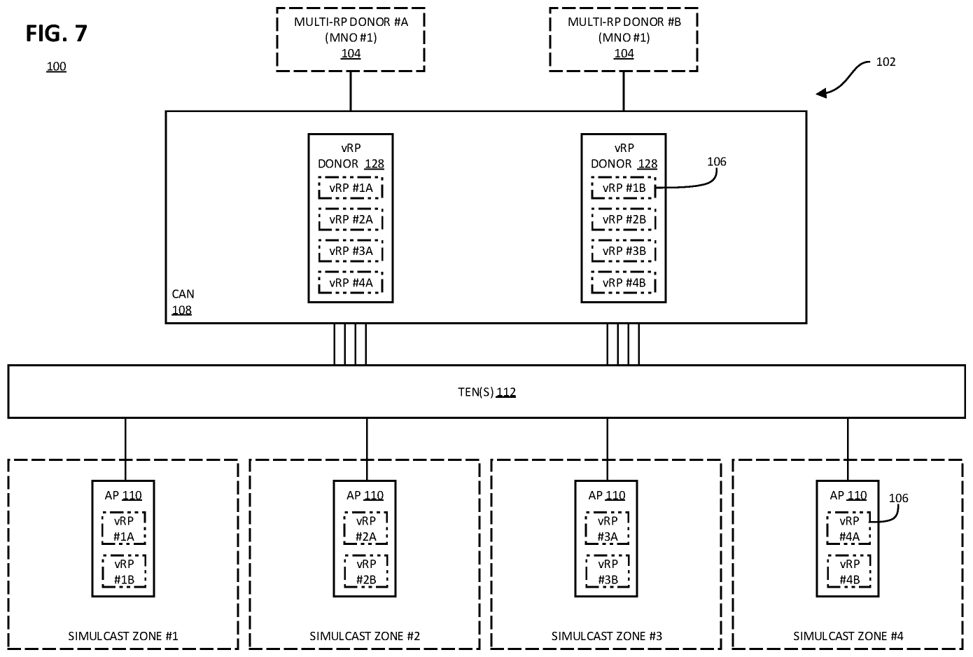

FIG. 7 illustrates a use case that is similar to the one shown in FIG. 6, except that each of the two multi-RP donors 104 is coupled to a different vRP donor interface 128.

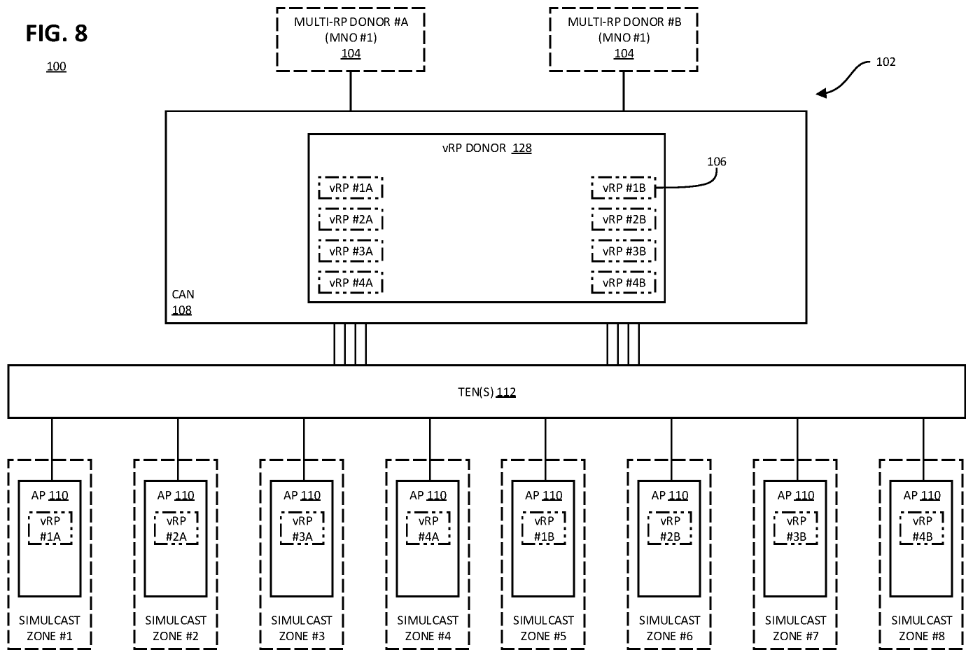

FIG. 8 illustrates a use case that is similar to the one shown in FIG. 6, except that the simulcast zone for each vRP 106 includes access points 110 that serve only one of the donors 104.

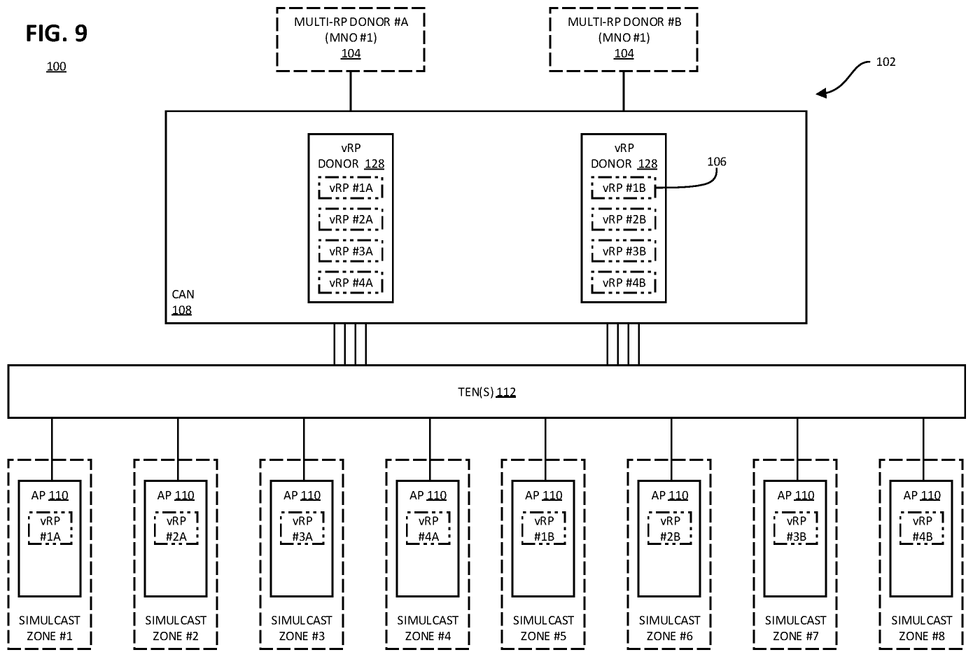

FIG. 9 illustrates a use case that is similar to the one shown in FIG. 7, except that the simulcast zone for each vRP 106 includes access points 110 that serve only one of the donors 104.

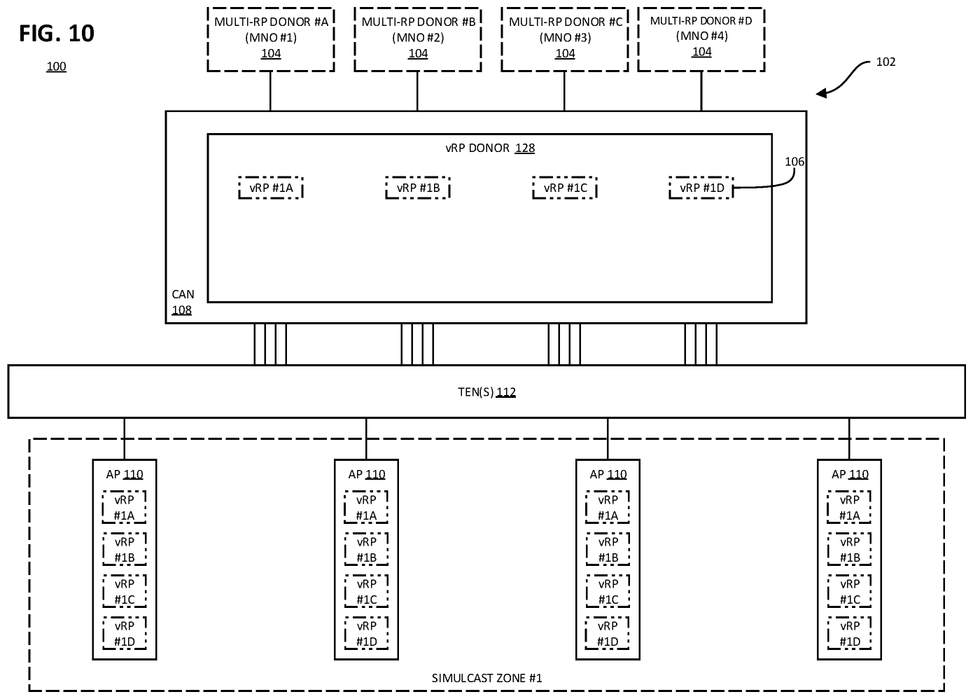

FIG. 10 illustrates a use case in which four multi-RP donors 104 are coupled to a single vRP donor interface 128 in a CAN 108 of the DAS 102. In this use case, four mobile network operators (MNOs) are being served, each MNO being served using one of the multi-RP donors 104. The DAS 102 instantiates a respective single vRP 106 for each of the four multi-RP donors 104 (and the respective base station and cell implemented thereby). In this use case, the respective simulcast zone for the single vRP 106 for each multi-RP donor 104 includes four access points 110.

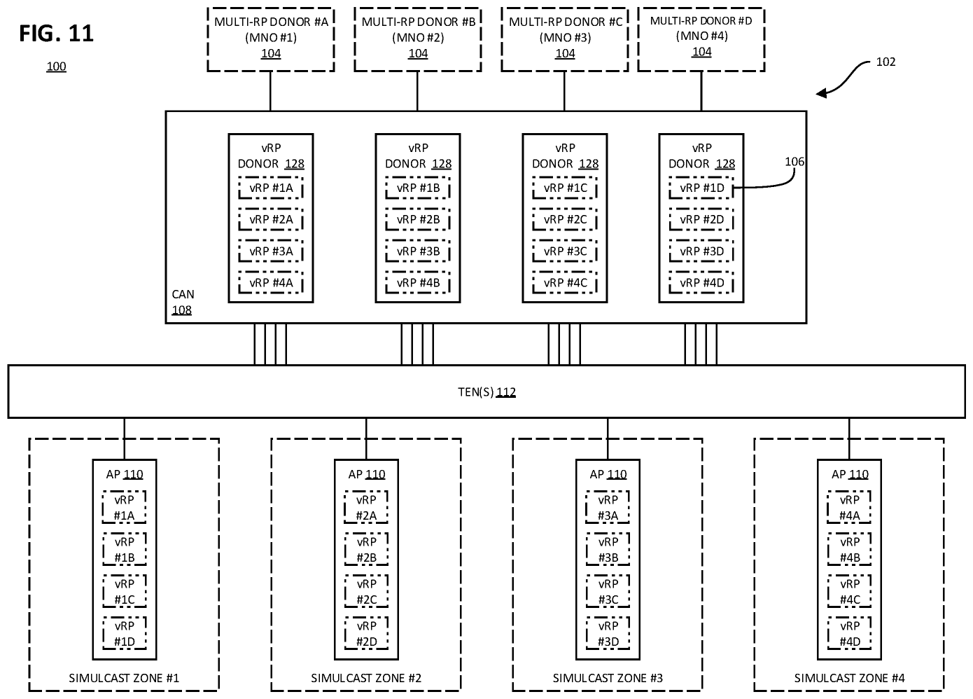

FIG. 11 illustrates a use case that is similar to the one shown in FIG. 10, except that each of the four multi-RP donors 104 is coupled to a different vRP donor interface 128 that is used to instantiate a respective four vRPs 106 for each of the four multi-RP donors 104 (and the respective base station and cell implemented thereby). The simulcast zone for each vRP 106 includes only one access point 110 in this example.

Other use cases and embodiments can be implemented in other ways.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### EXAMPLE EMBODIMENTS

Example 1 includes a converged system comprising: at least one donor base station entity configured to support natively work with multiple radio points; and a distributed antenna system communicatively coupled to the donor base station entity, wherein the distributed antenna system is configured to instantiate multiple virtual radio points for the donor base station entity; wherein the distributed antenna system is configured to serve the donor base station entity using the multiple virtual radio points instantiated by the distributed antenna system for the donor base station entity.

Example 2 includes the converged system of Example 1, wherein the distributed antenna system comprises a virtual radio point donor interface and a plurality of access points, wherein each virtual radio point is implemented using the virtual radio point donor interface and a respective one or more of the access points, wherein the respective one or more of the access points used to implement each virtual radio point comprises a respective simulcast zone for that virtual radio point.

Example 3 includes the converged system of Example 2, wherein the virtual radio point donor interface comprises a virtual radio point donor card.

Example 4 includes the converged system of any of Examples 2-3, wherein the distributed antenna system comprises a central access node, wherein the plurality of access points is communicatively coupled to the central access node.

Example 5 includes the converged system of Example 4, wherein the distributed antenna system further comprises at least one transport expansion node to communicatively couple at least some of the access points to the central access node.

Example 6 includes the converged system of any of Examples 2-5, wherein the distributed antenna system is configured to serve the donor base station entity using the multiple virtual radio points instantiated by the distributed antenna system for the donor base station entity by doing the following: receive, from the donor base station entity, downlink control-plane messages and downlink user-plane messages for each of the multiple virtual radio points; communicate the downlink control-plane messages and the downlink user-plane messages for each of the multiple virtual radio points to the one or more access points in the respective simulcast zone for the respective virtual radio point; receive, at each of the one or more access points in the respective simulcast zone for each virtual radio point, the downlink control-plane messages and the downlink user-plane messages for the respective virtual radio point; generate, at each of the one or more access points in the respective simulcast zone for each virtual radio point, downlink analog radio frequency signals for the respective virtual radio point using the downlink control-plane messages and the downlink user-plane messages for the respective virtual radio point; and wirelessly transmit, from each of the one or more access points in the respective simulcast zone for each virtual radio point, the respective downlink analog radio frequency signals generated for the respective virtual radio point.

Example 7 includes the converged system of any of Examples 2-6, wherein the distributed antenna system is configured to serve the donor base station entity using the multiple virtual radio points instantiated by the distributed antenna system for the donor base station entity by doing the following: receive, for the donor base station entity, downlink synchronization-plane messages and downlink management plane messages for each of the multiple virtual radio points; and process and/or respond to the downlink synchronization-plane messages and downlink management-plane messages received for each of the multiple virtual radio points.

Example 8 includes the converged system of any of Examples 2-7, wherein the distributed antenna system is configured to serve the donor base station entity using the multiple virtual radio points instantiated by the distributed antenna system for the donor base station entity by doing the following: wirelessly receive, at each of the one or more access points in the respective simulcast zone for each virtual radio point, respective uplink analog radio frequency signals for the respective virtual radio point; generate, at each of the one or more access points in the respective simulcast zone for each virtual radio point, uplink user-plane messages for the respective virtual radio point using the received uplink analog radio frequency signals for the respective virtual radio point; communicate, over the distributed antenna system, the uplink user-plane messages for each of the multiple virtual radio points generated by each of the one or more access points in the respective simulcast zone for the respective virtual radio point; generate, for the donor base station entity, donor uplink user messages for each of the multiple virtual radio points derived from the uplink user-plane messages for each of the multiple virtual radio points generated by each of the one or more access points in the respective simulcast zone for the respective virtual radio point and communicated over the distributed antenna system; and communicate the donor uplink user messages for each of the multiple virtual radio points to the donor base station entity.

Example 9 includes the converged system of any of Examples 2-8, wherein the DAS is configured to generate, for the donor base station entity, the donor uplink user messages for each of the multiple virtual radio points by performing a summing or combining process that uses as inputs the uplink user-plane messages for the respective virtual radio point generated by each of the one or more access points in the respective simulcast zone for the respective virtual radio point and communicated over the distributed antenna system.

Example 10 includes the converged system of any of Examples 2-9, wherein the distributed antenna system is configured to serve the donor base station entity using the multiple virtual radio points instantiated by the distributed antenna system for the donor base station entity by doing the following: generate any uplink donor synchronization-plane messages and donor uplink management-plane messages for each of the multiple virtual radio points; and communicate any uplink donor synchronization-plane messages and donor uplink management-plane messages generated for each of the multiple virtual radio points to an appropriate entity associated with the donor base station entity.

Example 11 includes the converged system of any of Examples 1-10, wherein the converged system further comprises at least one of a radio frequency (RF) donor base station and a digital donor base station entity; and wherein the distributed antenna system further comprises at least one of: a RF donor interface configured to couple the RF donor base station to the distributed antenna system and a digital donor interface configured to couple the digital donor base station entity to the distributed antenna system.

Example 12 includes the converged system of any of Examples 1-11, wherein the DAS is configured so that each virtual radio point instantiated and implemented for the donor base station entity appears to the donor base station entity to be a radio point of a type the donor base station entity is configured to work with.

Example 13 includes the converged system of any of Examples 1-12, wherein the donor base station entity is configured to implement one or more multi-radio-point features; and wherein the distributed antenna system is configured so that the multiple virtual radio points instantiated and implemented for the donor base station entity implement features necessary for implementing the one or more multi-radio-point features.

Example 14 includes the converged system of Example 13, wherein the one or more multi-radio-point features comprise one or more of the following: an uplink interference rejection combining (IRC) receiver, a noise muting receiver, a selection combining receiver, downlink frequency reuse, and uplink frequency reuse.

Example 15 includes the converged system of any of Examples 1-14, wherein the converged system comprises a plurality of donor base station entities, each configured to support natively working with multiple radio points; and wherein the distributed antenna system is communicatively coupled to each of the donor base station entities, wherein the distributed antenna system is configured to instantiate a respective set of multiple virtual radio points for each of the donor base station entities, wherein the distributed antenna system is configured to serve each of the donor base station entities using the respective multiple virtual radio points instantiated by the distributed antenna system for the respective donor base station entity.

Example 16 includes the converged system of Example 15, wherein the plurality of donor base station entities comprise donor base station entities operated by a plurality of mobile network operators.

Example 17 includes a method performed using a converged system comprising at least one donor base station entity configured to support natively work with multiple radio points, wherein the converged system further comprises a distributed antenna system communicatively coupled to the donor base station entity, wherein the distributed antenna system is configured to instantiate multiple virtual radio points for the donor base station entity, wherein the distributed antenna system comprises a virtual radio point donor interface and a plurality of access points, wherein each virtual radio point is implemented using the virtual radio point donor interface and a respective one or more of the access points, wherein the respective one or more of the access points used to implement each virtual radio point comprises a respective simulcast zone for that virtual radio point, wherein the method comprises: receiving, from the donor base station entity, downlink control-plane messages and downlink user-plane messages for each of the multiple virtual radio points; communicating the downlink control-plane messages and the downlink user-plane messages for each of the multiple virtual radio points to the one or more access points in the respective simulcast zone for the respective virtual radio point; receiving, at each of the one or more access points in the respective simulcast zone for each virtual radio point, the downlink control-plane messages and the downlink user-plane messages for the respective virtual radio point; generating, at each of the one or more access points in the respective simulcast zone for each virtual radio point, downlink analog radio frequency signals for the respective virtual radio point using the downlink control-plane messages and the downlink user-plane messages for the respective virtual radio point; and wirelessly transmitting, from each of the one or more access points in the respective simulcast zone for each virtual radio point, the respective downlink analog radio frequency signals generated for the respective virtual radio point.

Example 18 includes the method of Example 17, wherein the method further comprises: receiving, for the donor base station entity, downlink synchronization-plane messages and downlink management plane messages for each of the multiple virtual radio points; and processing and/or responding to the downlink synchronization-plane messages and downlink management-plane messages received for each of the multiple virtual radio points.

Example 19 includes the method of any of Examples 17-18, wherein the method further comprises: wirelessly receiving, at each of the one or more access points in the respective simulcast zone for each virtual radio point, respective uplink analog radio frequency signals for the respective virtual radio point; generating, at each of the one or more access points in the respective simulcast zone for each virtual radio point, uplink user-plane messages for the respective virtual radio point using the received uplink analog radio frequency signals for the respective virtual radio point; communicating, over the distributed antenna system, the uplink user-plane messages for each of the multiple virtual radio points generated by each of the one or more access points in the respective simulcast zone for the respective virtual radio point; generating, for the donor base station entity, donor uplink user messages for each of the multiple virtual radio points derived from the uplink user-plane messages for each of the multiple virtual radio points generated by each of the one or more access points in the respective simulcast zone for the respective virtual radio point and communicated over the distributed antenna system; and communicating the donor uplink user messages for each of the multiple virtual radio points to the donor base station entity.

Example 20 includes the method of Example 19, wherein generating, for the donor base station entity, the donor uplink user messages for each of the multiple virtual radio points comprises performing a summing or combining process that uses as inputs the uplink user-plane messages for the respective virtual radio point generated by each of the one or more access points in the respective simulcast zone for the respective virtual radio point and communicated over the distributed antenna system.

Example 21 includes the method of any of Examples 17-20, wherein the method further comprises: generating any uplink donor synchronization-plane messages and donor uplink management-plane messages for each of the multiple virtual radio points; and communicating any uplink donor synchronization-plane messages and donor uplink management-plane messages generated for each of the multiple virtual radio points to an appropriate entity associated with the donor base station entity.

Example 22 includes the method of any of Examples 17-21, wherein the donor base station entity is configured to implement one or more multi-radio-point features; and wherein the distributed antenna system is configured so that the multiple virtual radio points instantiated and implemented for the donor base station entity implement features necessary for implementing the one or more multi-radio-point features.

Example 23 includes the method of Example 22, wherein the one or more multi-radio-point features comprise one or more of the following: an uplink interference rejection combining (IRC) receiver, a noise muting receiver, a selection combining receiver, downlink frequency reuse, and uplink frequency reuse.

What is claimed is:

1. A converged system comprising:
at least one donor base station entity configured to support natively work with multiple radio points; and
a distributed antenna system communicatively coupled to the donor base station entity, wherein the distributed antenna system is configured to instantiate multiple virtual radio points for the donor base station entity;
wherein the distributed antenna system is configured to serve the donor base station entity using the multiple virtual radio points instantiated by the distributed antenna system for the donor base station entity.

2. The converged system of claim 1, wherein the distributed antenna system comprises a virtual radio point donor interface and a plurality of access points, wherein each virtual radio point is implemented using the virtual radio point donor interface and a respective one or more of the access points, wherein the respective one or more of the access points used to implement each virtual radio point comprises a respective simulcast zone for that virtual radio point.

3. The converged system of claim 2, wherein the virtual radio point donor interface comprises a virtual radio point donor card.

4. The converged system of claim 2, wherein the distributed antenna system comprises a central access node, wherein the plurality of access points is communicatively coupled to the central access node.

5. The converged system of claim 4, wherein the distributed antenna system further comprises at least one transport expansion node to communicatively couple at least some of the access points to the central access node.

6. The converged system of claim 2, wherein the distributed antenna system is configured to serve the donor base station entity using the multiple virtual radio points instantiated by the distributed antenna system for the donor base station entity by doing the following:
receive, from the donor base station entity, downlink control-plane messages and downlink user-plane messages for each of the multiple virtual radio points;
communicate the downlink control-plane messages and the downlink user-plane messages for each of the multiple virtual radio points to the one or more access points in the respective simulcast zone for the respective virtual radio point;
receive, at each of the one or more access points in the respective simulcast zone for each virtual radio point, the downlink control-plane messages and the downlink user-plane messages for the respective virtual radio point;
generate, at each of the one or more access points in the respective simulcast zone for each virtual radio point, downlink analog radio frequency signals for the respective virtual radio point using the downlink control-plane messages and the downlink user-plane messages for the respective virtual radio point; and
wirelessly transmit, from each of the one or more access points in the respective simulcast zone for each virtual radio point, the respective downlink analog radio frequency signals generated for the respective virtual radio point.

7. The converged system of claim 2, wherein the distributed antenna system is configured to serve the donor base station entity using the multiple virtual radio points instantiated by the distributed antenna system for the donor base station entity by doing the following:
receive, for the donor base station entity, downlink synchronization-plane messages and downlink management plane messages for each of the multiple virtual radio points; and
process and/or respond to the downlink synchronization-plane messages and downlink management-plane messages received for each of the multiple virtual radio points.

8. The converged system of claim 2, wherein the distributed antenna system is configured to serve the donor base station entity using the multiple virtual radio points instantiated by the distributed antenna system for the donor base station entity by doing the following:
wirelessly receive, at each of the one or more access points in the respective simulcast zone for each virtual radio point, respective uplink analog radio frequency signals for the respective virtual radio point;
generate, at each of the one or more access points in the respective simulcast zone for each virtual radio point, uplink user-plane messages for the respective virtual radio point using the received uplink analog radio frequency signals for the respective virtual radio point;
communicate, over the distributed antenna system, the uplink user-plane messages for each of the multiple virtual radio points generated by each of the one or more access points in the respective simulcast zone for the respective virtual radio point;
generate, for the donor base station entity, donor uplink user messages for each of the multiple virtual radio points derived from the uplink user-plane messages for each of the multiple virtual radio points generated by each of the one or more access points in the respective simulcast zone for the respective virtual radio point and communicated over the distributed antenna system; and
communicate the donor uplink user messages for each of the multiple virtual radio points to the donor base station entity.

9. The converged system of claim 2, wherein the DAS is configured to generate, for the donor base station entity, the donor uplink user messages for each of the multiple virtual radio points by performing a summing or combining process that uses as inputs the uplink user-plane messages for the respective virtual radio point generated by each of the one or more access points in the respective simulcast zone for the respective virtual radio point and communicated over the distributed antenna system.

10. The converged system of claim 2, wherein the distributed antenna system is configured to serve the donor base station entity using the multiple virtual radio points instantiated by the distributed antenna system for the donor base station entity by doing the following:
generate any uplink donor synchronization-plane messages and donor uplink management-plane messages for each of the multiple virtual radio points; and
communicate any uplink donor synchronization-plane messages and donor uplink management-plane messages generated for each of the multiple virtual radio points to an appropriate entity associated with the donor base station entity.

11. The converged system of claim 1, wherein the converged system further comprises at least one of a radio frequency (RF) donor base station and a digital donor base station entity; and
wherein the distributed antenna system further comprises at least one of: a RF donor interface configured to couple the RF donor base station to the distributed antenna system and a digital donor interface configured to couple the digital donor base station entity to the distributed antenna system.

12. The converged system of claim 1, wherein the DAS is configured so that each virtual radio point instantiated and implemented for the donor base station entity appears to the donor base station entity to be a radio point of a type the donor base station entity is configured to work with.

13. The converged system of claim 1, wherein the donor base station entity is configured to implement one or more multi-radio-point features; and
wherein the distributed antenna system is configured so that the multiple virtual radio points instantiated and implemented for the donor base station entity implement features necessary for implementing the one or more multi-radio-point features.

14. The converged system of claim 13, wherein the one or more multi-radio-point features comprise one or more of the following: an uplink interference rejection combining (IRC) receiver, a noise muting receiver, a selection combining receiver, downlink frequency reuse, and uplink frequency reuse.

15. The converged system of claim 1, wherein the converged system comprises a plurality of donor base station entities, each configured to support natively working with multiple radio points; and
wherein the distributed antenna system is communicatively coupled to each of the donor base station entities, wherein the distributed antenna system is configured to instantiate a respective set of multiple virtual radio points for each of the donor base station entities, wherein the distributed antenna system is configured to serve each of the donor base station entities using the respective multiple virtual radio points instantiated by the distributed antenna system for the respective donor base station entity.

16. The converged system of claim 15, wherein the plurality of donor base station entities comprise donor base station entities operated by a plurality of mobile network operators.

17. A method performed using a converged system comprising at least one donor base station entity configured to support natively work with multiple radio points, wherein the converged system further comprises a distributed antenna system communicatively coupled to the donor base station entity, wherein the distributed antenna system is configured to instantiate multiple virtual radio points for the donor base station entity, wherein the distributed antenna system comprises a virtual radio point donor interface and a plurality of access points, wherein each virtual radio point is implemented using the virtual radio point donor interface and a respective one or more of the access points, wherein the respective one or more of the access points used to implement each virtual radio point comprises a respective simulcast zone for that virtual radio point, wherein the method comprises:
receiving, from the donor base station entity, downlink control-plane messages and downlink user-plane messages for each of the multiple virtual radio points;
communicating the downlink control-plane messages and the downlink user-plane messages for each of the multiple virtual radio points to the one or more access points in the respective simulcast zone for the respective virtual radio point;
receiving, at each of the one or more access points in the respective simulcast zone for each virtual radio point, the downlink control-plane messages and the downlink user-plane messages for the respective virtual radio point;
generating, at each of the one or more access points in the respective simulcast zone for each virtual radio point, downlink analog radio frequency signals for the respective virtual radio point using the downlink control-plane messages and the downlink user-plane messages for the respective virtual radio point; and
wirelessly transmitting, from each of the one or more access points in the respective simulcast zone for each virtual radio point, the respective downlink analog radio frequency signals generated for the respective virtual radio point.

18. The method of claim 17, wherein the method further comprises:
receiving, for the donor base station entity, downlink synchronization-plane messages and downlink management plane messages for each of the multiple virtual radio points; and
processing and/or responding to the downlink synchronization-plane messages and downlink management-plane messages received for each of the multiple virtual radio points.

19. The method of claim 17, wherein the method further comprises:
wirelessly receiving, at each of the one or more access points in the respective simulcast zone for each virtual radio point, respective uplink analog radio frequency signals for the respective virtual radio point;
generating, at each of the one or more access points in the respective simulcast zone for each virtual radio point, uplink user-plane messages for the respective virtual radio point using the received uplink analog radio frequency signals for the respective virtual radio point;
communicating, over the distributed antenna system, the uplink user-plane messages for each of the multiple virtual radio points generated by each of the one or more access points in the respective simulcast zone for the respective virtual radio point;
generating, for the donor base station entity, donor uplink user messages for each of the multiple virtual radio points derived from the uplink user-plane messages for each of the multiple virtual radio points generated by each of the one or more access points in the respective simulcast zone for the respective virtual radio point and communicated over the distributed antenna system; and
communicating the donor uplink user messages for each of the multiple virtual radio points to the donor base station entity.

20. The method of claim 19, wherein generating, for the donor base station entity, the donor uplink user messages for each of the multiple virtual radio points comprises performing a summing or combining process that uses as inputs the uplink user-plane messages for the respective virtual radio point generated by each of the one or more access points in the respective simulcast zone for the respective virtual radio point and communicated over the distributed antenna system.

21. The method of claim 17, wherein the method further comprises:
generating any uplink donor synchronization-plane messages and donor uplink management-plane messages for each of the multiple virtual radio points; and
communicating any uplink donor synchronization-plane messages and donor uplink management-plane messages generated for each of the multiple virtual radio points to an appropriate entity associated with the donor base station entity.

22. The method of claim 17, wherein the donor base station entity is configured to implement one or more multi-radio-point features; and
wherein the distributed antenna system is configured so that the multiple virtual radio points instantiated and implemented for the donor base station entity implement features necessary for implementing the one or more multi-radio-point features.

23. The method of claim 22, wherein the one or more multi-radio-point features comprise one or more of the following: an uplink interference rejection combining (IRC) receiver, a noise muting receiver, a selection combining receiver, downlink frequency reuse, and uplink frequency reuse.
